(19) United States
(12) Patent Application Publication
(10) Pub. No.: US 2012/0217426 A1
(43) Pub. Date: Aug. 30, 2012

(54) VALVE APPARATUS HAVING A DOUBLE-OFFSET SHAFT CONNECTION

(76) Inventors: Andrew James Berthelsen, Marshalltown, IA (US); Charles Robert Kuhlman, Marshalltown, IA (US); Ronald Ray Brestel, Marshalltown, IA (US)

(21) Appl. No.: 13/034,388

(22) Filed: Feb. 24, 2011

(51) Int. Cl. F16K 5/06

(52) U.S. Cl. 251/309; 251/315.01

(57) ABSTRACT

Valve apparatus having a double-offset shaft connection are described herein. An example flow control member includes a sealing surface to move relative to a seal where the flow control member has a first axis and a second axis substantially perpendicular to the first axis and the first and second axes intersect a center of curvature of the sealing surface. The flow control member also includes an opening to receive a shaft where the opening has a third axis passing through the opening to define a pivot about which the sealing surface rotates. The third axis is offset from the first and second axes.

### FIELD OF THE DISCLOSURE

This disclosure relates generally to control valves and, more particularly, to valve apparatus having a double-offset shaft connection.

### BACKGROUND

Process control plants or systems often employ rotary valves, such as, for example, ball valves, to control the flow of process fluids. Rotary valves typically include a valve apparatus or fluid flow control member (e.g., a ball valve) disposed in a fluid flow path and rotatably coupled to the body of the rotary valve via a shaft. Typically, a portion of the shaft extending from the rotary valve is operatively coupled to an actuator (e.g., a pneumatic actuator, an electric actuator, a hydraulic actuator, etc.). The actuator causes the flow control member to move through a 90 degree rotation relative to a seal surrounding an orifice of the fluid flow path between a fully open position to allow maximum fluid flow through the fluid flow path and a fully closed position to substantially restrict or prevent fluid flow through the fluid flow path. In the closed position, a sealing surface of the flow control member engages the seal to prevent fluid flow through the fluid flow path.

In some applications, a sealing surface of the flow control member includes a notch (e.g., a micro V-notch ball valve) to precisely or accurately control fluid flow through the fluid flow path. In particular, the notch provides a gradual increase in the amount of fluid flow through the flow path as the flow control member rotates or moves through a first or initial amount of rotational travel (e.g., zero to ten degrees of travel) relative to the seal. To provide the controlled fluid flow rate through the initial amount of rotational travel, process fluid is allowed to flow through a small, but gradually increasing gap formed between the seal and the notch. Fluid flows through the flow path of the valve body when the notch moves or rotates in fluid communication with the flow path of the valve body. However, a contact pressure or interference between the flow control member and the seal may cause a portion of the seal (e.g., an elastomeric seal) to become deformed or damaged when the flow control member is held in an open position (e.g., a fully open position) for an extended period of time.

### SUMMARY

In one example, a flow control member includes a sealing surface to move relative to a seal where the flow control member has a first axis and a second axis substantially perpendicular to the first axis and the first and second axes intersect a center of curvature of the sealing surface. The flow control member also includes an opening to receive a shaft where the opening has a third axis passing through the opening to define a pivot about which the sealing surface rotates. The third axis is offset from the first and second axes.

In another example, a valve plug includes a sealing surface to engage a seal of a fluid valve where the sealing surface has a center of curvature defined at least in part by a radius of curvature of the sealing surface. The valve plug includes an opening to receive a shaft. The opening has a central axis that is offset by a cam distance relative to the center of curvature of the sealing surface such that the sealing surface moves in a cammed or eccentric manner about the central axis of the opening. The cam distance is defined by a first distance relative to the center curvature and a second distance relative to the center of curvature.

In yet another example, a fluid valve includes a valve plug having a sealing surface that is to rotate relative to a seal of a valve body to control a fluid flow between an inlet and an outlet of the valve body. A shaft operatively couples the valve plug to an actuator. The shaft is eccentrically coupled to the valve plug to define a double-offset pivot about which the sealing surface rotates between a fully open position and a fully closed position.

### BRIEF DESCRIPTION OF THE DRAWINGS

FIG. 1A depicts a partial cutaway view of a known rotary valve.

FIG. 1B is a cross-sectional view of the known rotary valve of FIG. 1A.

FIG. 2A is an enlarged cross-sectional view of the known rotary valve of FIGS. 1A and 1B, showing the rotary valve in a closed position.

FIG. 2B is an enlarged cross-sectional view of the known rotary valve of FIGS. 1A and 1B, showing the rotary valve in an open position.

FIG. 3 is a partial cross-sectional view of a flow control member and a seal of the rotary valve of FIGS. 1A and 1B when the rotary valve is in an open position viewed along a fluid flow path of the rotary valve.

FIG. 4A illustrates another view of a known rotary valve looking along an axis of the shaft when the rotary valve is in a closed position.

FIG. 4B illustrates the rotary valve of FIG. 4A when the rotary valve is in an open position.

FIG. 5 illustrates a cross-section of an example rotary valve described herein.

FIG. 6A illustrates an example flow control member of the example rotary valve of FIG. 5 shown in a closed position.

FIG. 6B illustrates the example flow control member of the example rotary valve of FIGS. 5 and 6A shown in an open position.

FIG. 7 illustrates an enlarged portion of the example flow control member of FIGS. 6A and 6B.

FIG. 8 is an enlarged view of another example flow control member described herein shown in a closed position and an open position.

FIGS. 9A, 9B and 9C illustrate example offset and move back positions of the flow control member of FIG. 8 when a starting angle of the flow control member is −17 degrees and a cam distance is 0.015 inches.

FIGS. 10A, 10B and 10C illustrate example offset and move back positions of the flow control member of FIG. 8 when a starting angle of the flow control member is −10 degrees and a cam distance is 0.015 inches.

FIGS. 11A, 11B and 11C illustrate example offset and move back positions of the flow control member of FIG. 8 when a starting angle of the flow control member is −3 degrees and a cam distance is 0.015 inches.

### DETAILED DESCRIPTION

In general, the example rotary valves described herein provide a double-offset or double-cam connection between a shaft and a flow control member to significantly reduce or eliminate interference between a sealing surface of the flow control member and a seal when the flow control member is in an open position. More specifically, the example double-offset shaft connections described herein enable a sealing surface of a flow control member to pull back or move away a relatively greater distance from a face of a seal of a valve body than a conventional shaft and flow control member connection when the flow control member is in an open position, thereby significantly reducing or eliminating interference between the flow control member and the seal. Further, the example double-offset shaft connections described herein also enable the sealing surface of the flow control member to pull back from a face of the seal a relatively smaller distance during an initial amount of travel (e.g., from closed to fifteen degrees) than, for example, a conventional single-offset or non-offset shaft connection. As a result, the example double-offset shaft connections described herein enable accurate or precise fluid flow rate control during this initial amount of travel or rotation of the flow control member while significantly reducing interference between the flow control member and the seal for rotational positions near to or at a fully open condition. Additionally, like conventional flow control members and shaft connections, the example double-offset cam connections described herein provide a substantial interference between the sealing surface and the seal to provide a relatively tight seal when the flow control member is in a closed position.

In some examples, a sealing surface of the flow control member includes a center of curvature defined by at least in part by a radius of curvature of the sealing surface. The center of curvature of the sealing surface moves in a cammed or eccentric manner about a shaft that is positioned to function as a double-offset pivot. In some examples, the center of curvature of the sealing surface lies along an axis of symmetry of the flow control member. A second axis of the flow control member perpendicular to the axis of symmetry also intersects the center of curvature. A pivot axis about which the sealing surface moves or rotates is offset relative to the axis of symmetry and the second axis of the flow control member to provide a double-offset pivot. The double-offset pivot or shaft connection also enables the sealing surface of the flow control member to move a relatively small distance away from a face of a seal during a first or initial rotational position range such as when the flow control member rotates between, for example, a zero degree rotational position relative to a flow path axis and a fifteen degree rotational position relative to the flow path axis. In this manner, the flow control member enables a relatively small, precise or controlled fluid flow through a flow path of a rotary valve when the sealing surface moves away from the seal during the first or initial rotational position range. Further, the example double-offset shaft connections described herein enable the sealing surface to pull back or move away from a face of the seal a relatively greater distance during a second rotational position range such as when the flow control member rotates between, for example, a fifteen degree rotational position and a ninety degree rotational position.

Thus, the example double-offset shaft connections described herein enable a sealing surface of the flow control member to engage a seal with relatively less interference or sealing force when the flow control member is in a fully open position. This significantly reduces or prevents damage to the seal when the flow control member is held in the fully open position for an extended period of time during, for example, a failure condition, a normally open condition, etc., while still providing substantial interference to provide a tight seal when the flow control member is in the closed position.

Further, because a distance of the example double-offset connections described herein is smaller than a lateral pull back distance provided when the flow control member is in a fully open position, the double-offset connections described herein can be used with unmodified known rotary valve bodies. Thus, the example double-offset connections described herein reduce manufacturing and inventory costs.

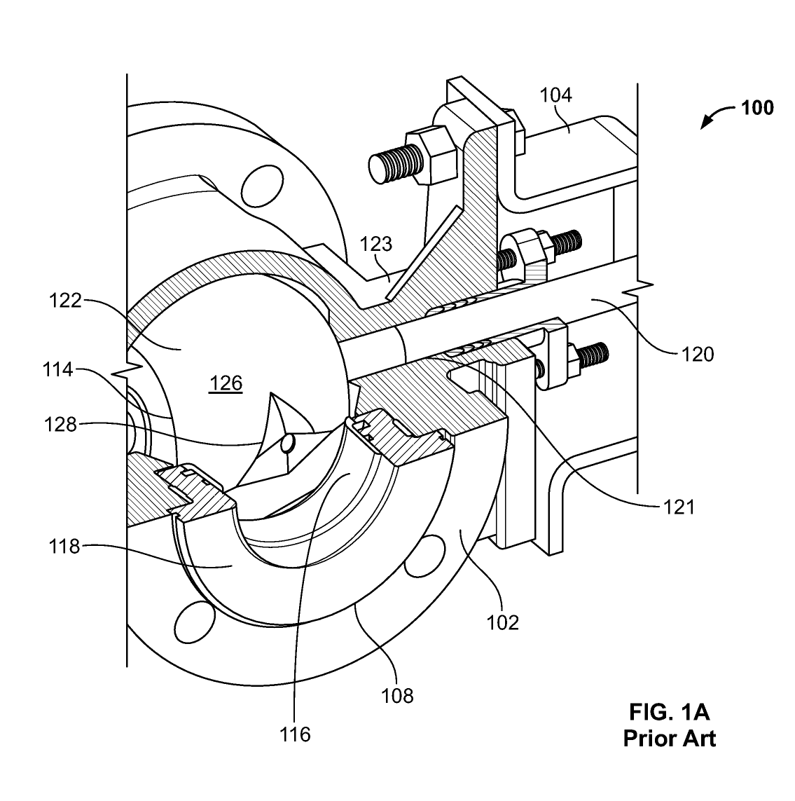

Before describing an example rotary valve in greater detail, a brief description of a known rotary valve 100 is provided below in connection with FIGS. 1A and 1B. FIG. 1A is a partial cut-away view of the known rotary valve 100. FIG. 1B is a cross-sectional view of the rotary valve 100 of FIG. 1A.

Referring in detail to FIGS. 1A and 1B, the rotary valve 100 includes a valve body 102 that may be coupled to an actuator (not shown) via a mounting yoke 104. For example, the actuator (not shown) may be a pneumatic actuator, an electric actuator, a hydraulic actuator, a manual actuator, or any other suitable actuator to move the rotary valve 100 between an open position and a closed position.

Referring to FIG. 1B, the valve body 102 defines a fluid flow pathway 106 between an inlet 108 and an outlet 110, where the fluid flow pathway 106 defines a fluid flow axis 112. The valve body 102 houses a valve plug or flow control member 114 (e.g., a V-notched ball valve, a spherical ball valve, etc.) adjacent a seating surface or seal 116 (e.g., a seal ring) that defines an orifice of the rotary valve 100. In this example, the seal 116 is composed of an elastomeric material and is coupled to the valve body 102 via a retainer 118. The valve plug 114 is coupled to a shaft 120, which operatively couples the valve plug 114 to the actuator (not shown). The shaft 120 is received within a bore 121 of a bonnet 123 coupled to the valve body 102.

The valve plug 114 is disposed within the fluid flow pathway 106 and moves or rotates relative to the seal 116 to control fluid flow through or along the fluid flow pathway 106. In this example, the valve plug 114 includes a sealing surface 122 that rotatably engages the seal 116 to control the flow of fluid through the orifice between the inlet 108 and the outlet 110. In particular, the sealing surface 122 rotates or pivots relative to a face 124 of the seal 116 such that a fluid flow rate through the rotary valve 100 is controlled by the rotational position of the valve plug 114 relative to the seal 116.

In the illustrated example, the sealing surface 122 includes a curved surface 126 and a notched portion 128. The position of the valve plug 114 may be varied between a closed position at which the sealing surface 122 of the valve plug 114 is in sealing engagement with the seal 116 and a fully open or maximum flow rate position at which the valve plug 114 is rotated relative to the seal 116 such that the notched portion 128 permits fluid flow between the inlet 108 and the outlet 110 along the flow path 106 via the notched portion 128. In the closed position, the notched portion 128 is substantially perpendicular relative to the flow path axis 112, thereby preventing fluid flow through the fluid flow pathway 106.

The notched portion 128 is advantageous for use in very precise flow control applications. In particular, the notched portion 128 provides a gradually increasing flow rate through the valve body 102 as the sealing surface 122 is rotated relative to the seal 116 from a closed position toward a partially open position (e.g., a 5 degree rotation relative to the flow path axis 112).

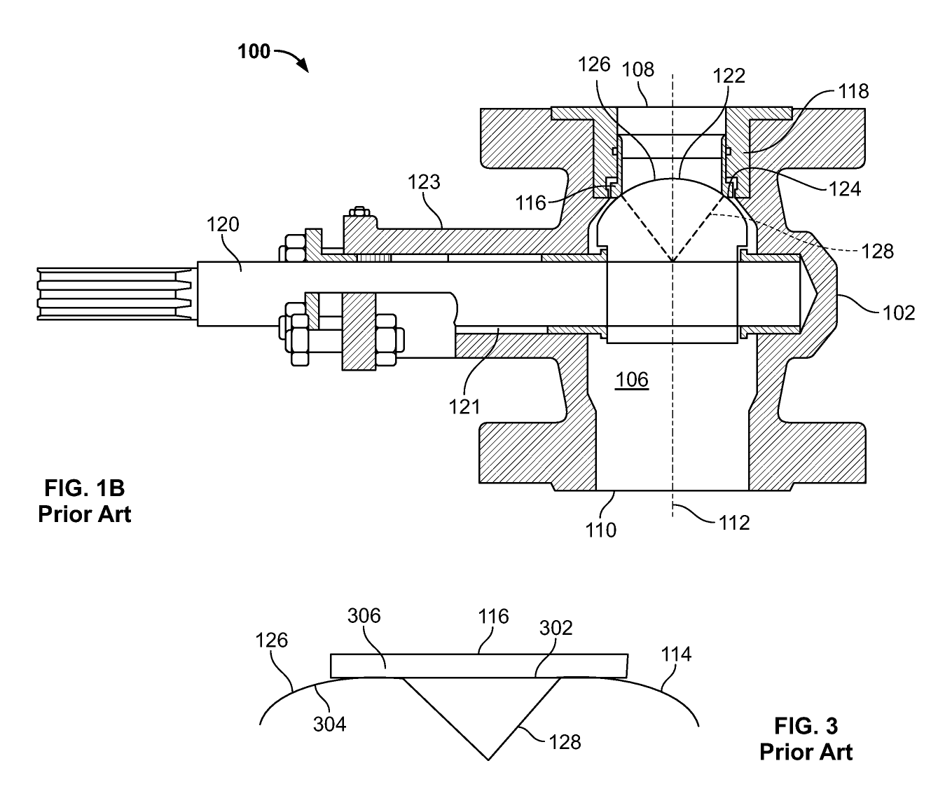

FIG. 2A illustrates a cross-sectional view of the valve plug 114 shown in a closed position 200 relative to the seal 116. FIG. 2B illustrates a cross-sectional view of the valve plug 114 shown in an open position 202 relative to the seal 116. As shown in FIGS. 2A and 2B, the sealing surface 122 of the valve plug 114 has a center of curvature 204 and a radius of curvature R.

The valve plug 114 includes an opening 206 to receive the shaft 120. In this example, the opening 206 is substantially perpendicular to the flow path axis 112 and parallel to the face 124 of the seal 116. The opening 206 defines a central axis 208 that intersects the center of curvature 204 of the sealing surface 122 such that the sealing surface 122 pivots about the central axis 208 of the opening 206. In other words, the pivot axis of the valve plug 114 is not offset relative to the center of curvature 204 of the sealing surface 122.

As shown in FIG. 2A, the sealing surface 122 sealingly engages the seal 116 to prevent or substantially restrict fluid flow through an orifice 209 defined by the seal 116. When coupled to the valve body 102, the center of curvature 204 of the sealing surface 122 intersects a central or longitudinal axis 210 of the seal 116. The central axis 210 is also coincident with the central axis 112 of the flow path 106 through the orifice 209 defined by the seal 116. In this manner, a seal load is evenly or uniformly distributed about a circumference or perimeter of the seal 116. Offsetting the center of curvature 204 of the sealing surface 122 relative to the central axis 210 of the seal 116 when the surface 122 is engaged with the seal 116 may cause an uneven load on the seal 116 when the sealing surface 122 engages the seal 116.

When the valve plug 114 is in the closed position 200 as shown in FIG. 2A, the sealing surface 122 is positioned relative to the seal 116 such that the sealing surface 122 provides substantial interference with the seal 116 to provide a tight fluid seal. More specifically, in the closed position 200, the sealing surface 122 presses against the elastomeric seal 116, causing the elastomeric seal 116 in contact with the sealing surface 122 to deflect and/or deform. To provide interference between the seal 116 and the sealing surface 122, the valve plug 114 is positioned relative to the seal 116 such that an outer most tangent 212 of the sealing surface 122 is at an initial lateral distance 214 relative to the center of curvature 204 of the sealing surface 122 when the valve plug 114 is in the closed position 200. In the closed position 200, the tangent 212 is substantially parallel to the face 124 of the seal 116.

FIG. 2B illustrates the valve plug 114 in the open position 202. When the valve plug 114 moves to the open position 202, the center of curvature 204 of the sealing surface 122 and the central axis 208 of the opening 206 still intersect the central axis 210 of the seal 116. Additionally, the valve plug 114 is positioned relative to the seal 116 such that an outer most tangent 218 of the sealing surface 122 is at distance 220 that is substantially equal to the distance 214. Thus, the pivot 216 does not provide a pull-back or displacement between the center 204 of the sealing surface 122 and the seal 116 when the valve plug 114 rotates between the closed position 200 and the open position 202 because the sealing surface 122 pivots about its center of curvature 204.

Thus, the sealing surface 122 engages portions (e.g., outer portions) of the seal 116 when the valve plug 114 is in the open position 202 and a portion of the seal 116 (e.g., a portion between the notched portion 128) is unsupported. Additionally, the sealing surface 122 engages the seal 122 (e.g., the outer portions) with substantially the same sealing force or interference as the sealing surface 122 engages the seal 116 when the valve plug 114 is in the closed position 200.

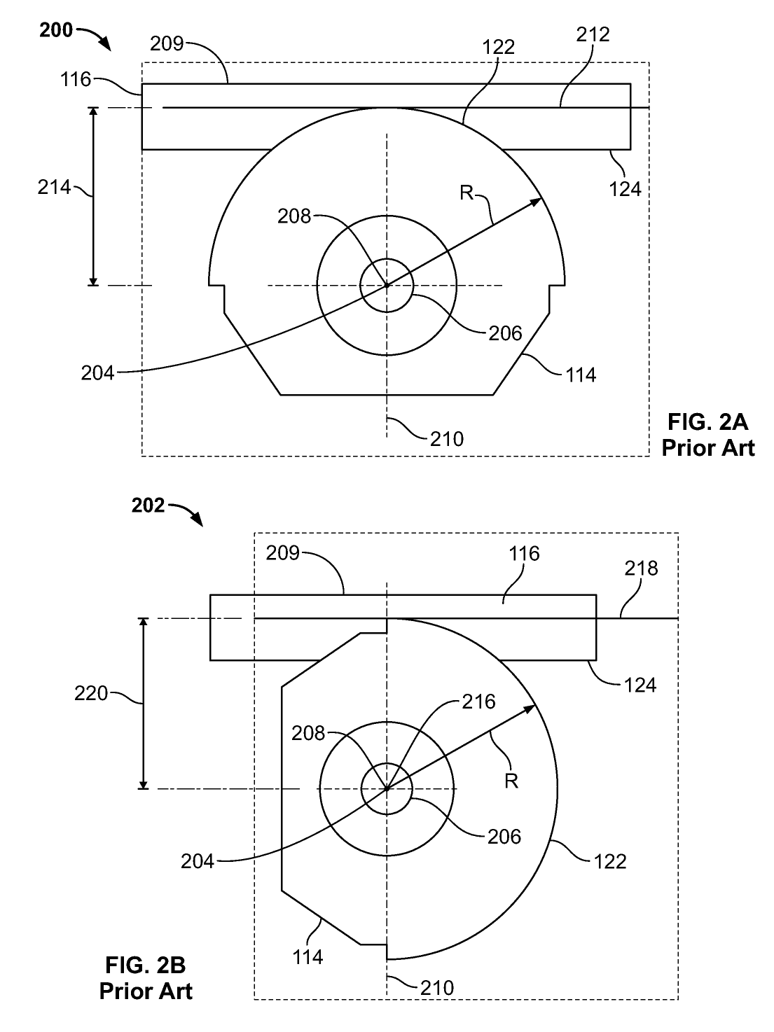

FIG. 3 illustrates a partial cross-sectional view of the valve plug 114 and the seal 116 when the valve plug 114 is in the open position 202 viewed toward the seal 116 along the central flow path axis 112 of the valve body 102. In the open position 202, a portion 302 of the seal 116 along the notched portion 128 is unsupported. Additionally, a portion 304 of the sealing surface 122 sealingly engages a portion 306 of the seal 116 adjacent the notched portion 128 with the same sealing force or interference with which the sealing surface 122 engages the seal 116 in the closed position 200. As a result, the sealing surface 122 imparts a stress or high stress concentration to the seal 116 along the edges of the notched portion 128. When the valve plug 114 is in the open position 202 for an extended of time (e.g., a fail to open condition, a normally open valve, etc.), the portion 302 of the seal 116 that is unsupported may become deformed or damaged, particularly at areas of high stress concentration such as along the edges of the notched portion 128. Accordingly, the seal 116 may not provide a tight fluid seal when the sealing surface 122 sealingly engages the portion 302 of the seal 116 when the valve plug 114 is moved to the closed position 200.

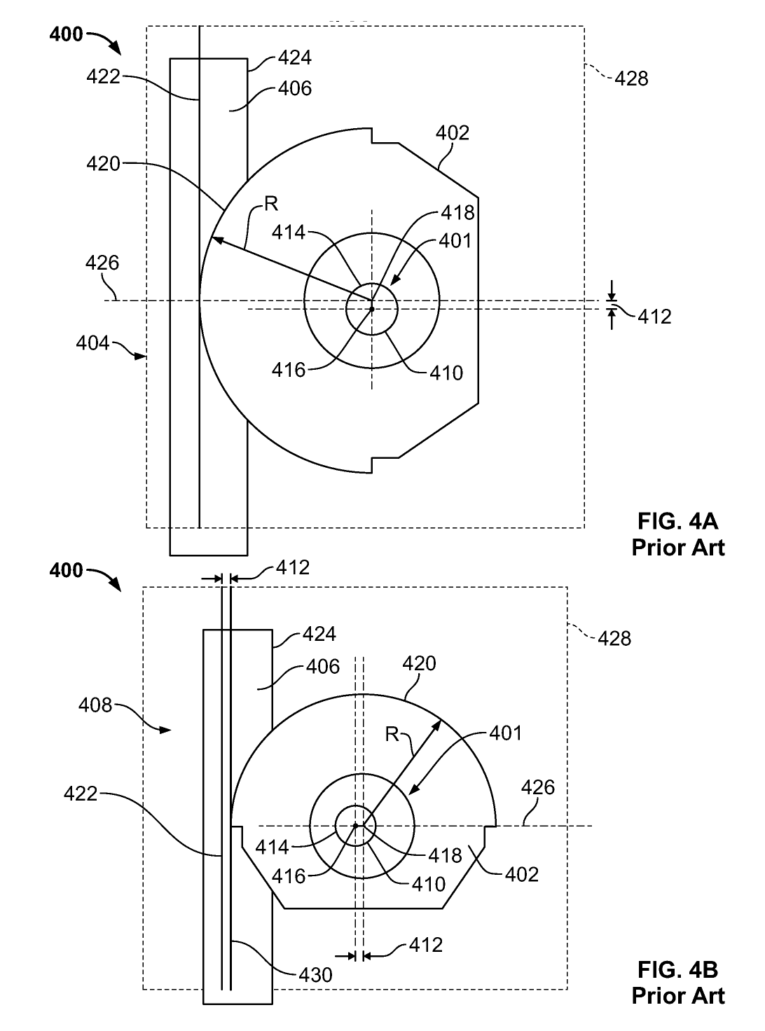

FIG. 4A illustrates a cross-sectional view of another known rotary valve 400 that provides a single-offset shaft connection 401. FIG. 4A illustrates a known valve plug 402 shown in a closed position 404 relative to a seal 406. FIG. 4B illustrates the valve plug 402 shown in an open position 408 relative to the seal 406. Unlike the valve plug 114 of FIGS. 1A, 1B, 2A, 2B and 3, a shaft 410 is coupled to the valve plug 402 to provide a single-offset connection or pivot axis. In other words, the valve plug 402 includes an opening 414 having a central axis or pivot axis 416 that is offset relative to a center of curvature 418 of a sealing surface 420 of the valve plug 402. Thus, the pivot axis 416 and the center of curvature 418 of the sealing surface 420 do not intersect.

When in the closed position 404, the sealing surface 420 sealingly engages the seal 406 such that an outer most tangent 422 of the sealing surface 420 is parallel to and adjacent a face 424 of the seal 406. Additionally, in the closed position 404, the center of curvature 418 of the sealing surface 420 lies along a central flow path or axis 426 of a valve body 428 and the seal 406. However as can be seen in FIGS. 4A and 4B, the pivot axis 416 does not intersect the center of curvature 418 of the sealing surface 420. More specifically, in the closed position 404, the pivot axis 416 and the center of curvature 418 are equidistant from the tangent line 422 and are offset a distance 412 as described in greater detail below.

When the valve plug 402 is rotated to the open position 408 of FIG. 2B, an outer most tangent 430 of the sealing surface 420 is parallel to and offset from the tangent 422 by the distance 412. As a result, a sealing force or interference between the seal 406 and the sealing surface 420 is significantly reduced or eliminated when the valve plug 402 is in the open position 408. In other words, the center of curvature 418 of the sealing surface 420 moves away from the face 424 of the seal 406 by the offset distance 412 as the valve plug 402 rotates from the closed position 404 to the open position 408. The reduced interference between the sealing surface 420 and the seal 406 or pull back provided by the offset distance 412 may prevent a relatively small portion (e.g., the portion 302 of FIG. 3) of the seal 406 between a notched portion (e.g., the notched portion 128 of FIGS. 1A and 1B) from becoming deformed or damaged when the valve plug 402 is in the open position 408 for an extended period of time.

Thus, the single-offset connection 401 has pivot axis 416 about which the sealing surface 420 rotates that is coplanar with the center of curvature 418 of the sealing surface 420. Such a connection may be disadvantageous in some applications. For example, the offset distance 412 may cause a relatively high fluid flow rate (e.g., too much fluid flow) through a flow path of the valve body 428 because the sealing surface 420 may pull away from the face 424 of the seal 406 too quickly within, for example, an initial rotational position range (e.g., a five degree rotation) of the valve plug 402 relative to the seal 406. Thus, the offset distance 412 provided in FIGS. 4A and 4B may cause too much fluid flow through the valve body 428, thereby affecting fluid flow control and reducing the accuracy of the rotary valve 400.

Further, a pull back of the sealing surface 420 away from the seal 406 is substantially equal to the distance of the offset distance 412. In some instances, a different valve body may be required or the valve body 428 may need to be modified to accommodate the single-offset distance 412 if that distance is too large and causes interference between a valve body (e.g., an unmodified valve body) and/or other components (e.g., walls of a fluid flow path). For example, if the offset distance 412 is too large, a shaft may interfere with a bore of a bonnet of a valve body. Additionally, reducing the offset distance 412 may provide an inadequate pull back to reduce the interference between the sealing surface 420 and the seal 406 to prevent damage to the seal 406. In other words, if the offset 412 is too small, the valve plug 402 will not lose contact with (i.e., pull back from) the seal 406.

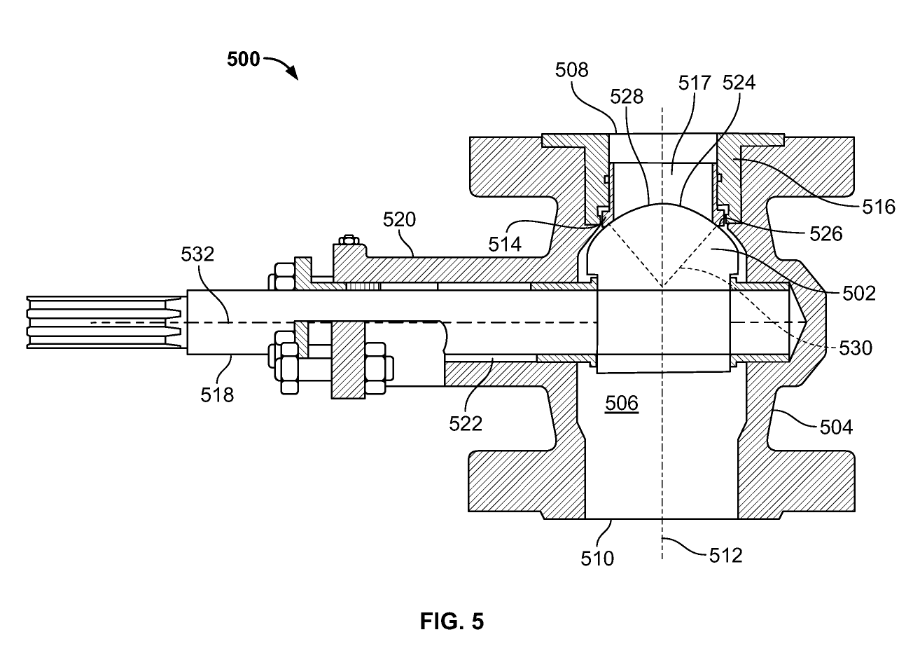

FIG. 5 illustrates a cross-sectional view of an example rotary fluid valve 500 having an example flow control member 502 described herein. The rotary fluid valve 500 includes a valve body 504 defining a fluid flow path or passageway 506 between an inlet 508 and an outlet 510. In this example, the fluid flow passageway 506 is a substantially straight fluid flow path defining a central flow path axis 512. The flow control member 502 is disposed within the fluid flow passageway 506 to control the fluid flow between the inlet 508 and the outlet 510. A seal 514 is coupled to the fluid flow passageway 506 via a retainer 516 adjacent the inlet 508 of the fluid flow passageway 506. The seal 514 defines an orifice 517 of the fluid flow passageway 506. In this example, the seal 514 is a soft or elastomeric seal such as, for example, a PTFE seal, a mineral soft seal, etc. A shaft 518 operatively couples the flow control member 502 to an actuator (not shown), which rotates the flow control member 502 relative to the seal 514 to control fluid flow through the passageway 506. In particular, in this example, the flow control member 502 moves through a 90 degree rotation or quarter turn to move between a closed position (e.g., a fully closed position) and an open position (e.g., a fully open position). A bonnet 520 having a bore 522 to receive a portion of the shaft 518 couples the valve body 504 to a mounting bracket or yoke (not shown) of the actuator (not shown). The actuator may be a pneumatic actuator, an electric actuator, a manual actuator (e.g., a handwheel) or any other type of actuator to rotate the flow control member 502 relative to the seal 514 via, for example, the shaft 518.

The flow control member 502 may be a valve plug, a Micro-Vee notched ball, a spherical ball valve, etc. In this example, the flow control member 502 includes a sealing surface 524 that rotatably engages the seal 514 to control the flow of fluid through the orifice between the inlet 508 and the outlet 510. In particular, the sealing surface 524 includes a curved or spherical surface that rotates or moves relative to a face 526 of the seal 514 such that a fluid flow rate through or along the rotary valve 500 is controlled by the rotational position of the flow control member 502 relative to the seal 514.

In the illustrated example, the sealing surface 524 includes a curved surface 528 and a notched portion 530. The position of the flow control member 502 may be varied between a closed position at which the sealing surface 524 is in sealing engagement with the seal 514 and a fully open or maximum flow rate position at which the sealing surface 524 is rotated relative to the seal 514 such that the notched portion 530 provides fluid communication between the inlet 508 and the outlet 510 via the notched portion 530. In a closed position, the notched portion 530 does not provide a fluid path between the inlet 508 and the outlet 510.

Thus, the notched portion 530 is aligned or moved to provide fluid communication between the inlet 508 and the outlet 510 to allow fluid flow along the fluid flow passageway 506 when flow control member 502 is in an open position. The notched portion 530 is substantially advantageous for use in accurate or precise flow control applications because the notched portion 530 provides a gradually increasing flow rate through the valve body 504 as the sealing surface 524 is rotated relative to the seal 514 from a closed position toward a partially open position (e.g., a 5 degree rotation relative to the central flow path axis 512).

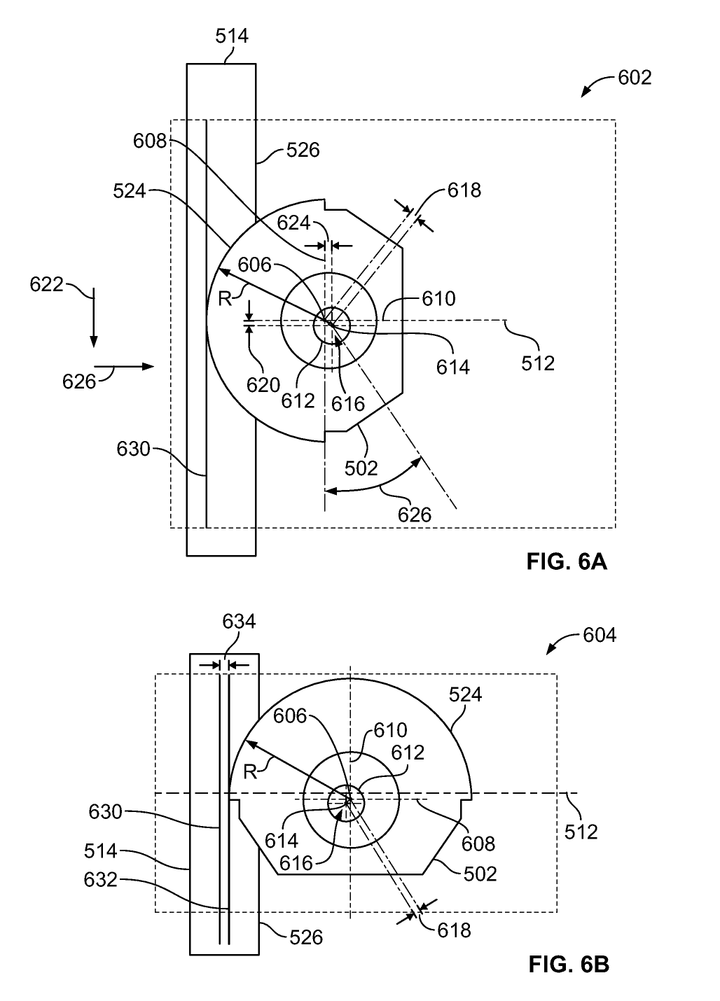

FIG. 6A is a cross-sectional side view of the flow control member 502 viewed along a longitudinal axis 532 (FIG. 5) of the shaft 518 when the flow control member 502 is in a closed position 602 relative to the seal 514. FIG. 6B is a cross-sectional side view of the flow control member 502 viewed along the longitudinal axis 532 of the shaft 518 when the flow control member 502 is an open position 604 relative to the seal 514. In this example, the sealing surface 524 includes the curved surface or portion (e.g., a curved or spherically shaped surface) having a center of curvature 606 defined at least in part by a radius of curvature R. The center of curvature 606 of the sealing surface 524 lies at the intersection of a first axis or axis of symmetry 608 and a second axis 610 substantially perpendicular to the first axis or axis of symmetry 608. As shown in FIG. 6A, the first axis 608 is substantially perpendicular to the central flow path axis 512 and the second axis 610 is substantially parallel to the central flow path axis 512 when the flow control member 502 is in the closed position 602. In contrast, when the flow control member 502 is rotated to the open position 604 as shown in FIG. 6B, the first axis 608 is substantially parallel to the central flow path axis 512 and the second axis 610 is substantially perpendicular to the central flow path axis 512.

The flow control member 502 includes an opening 612 to receive the shaft 518 (FIG. 5). In this example, the opening 612 is substantially perpendicular to the face 526 of the seal 514. The opening 612 defines a central axis 614 that is substantially perpendicular to the first and second axes 608 and 610 and coaxially aligned with the axis 532 (FIG. 5) of the shaft 518. Further, the central axis 614 of the opening 612 is offset relative to the first and second axes 608 and 610. In particular, the central axis 614 of the opening 612 defines a pivot or pivot axis 616 (e.g., a double-offset pivot) of the flow control member 502 about which the sealing surface 524 rotates between the closed position 602 and the open position 604. The pivot 616 is offset relative to the center of curvature 606 of the sealing surface 524 by a cam distance or offset 618. More specifically, the shaft 518 is eccentrically coupled to the flow control member 502 such that the pivot 616 functions as a double-offset pivot or shaft connection about which the sealing surface 524 rotates between the closed position 602 and the open position 604. The cam distance 618 between the center of curvature 606 and the pivot 616 is defined by both a first distance 620 (e.g., a first lateral distance) in a first direction 622 away from the center of curvature 606 of the sealing surface 524 along the longitudinal axis 608 when the flow control member is in the closed position 602, and a second distance 624 (e.g., a second lateral distance) in a second direction 626 away from the center of curvature 606 or the longitudinal axis 608 when the flow control member 502 is in the closed position 602. In this example, the first direction 622 is substantially perpendicular to the second direction 624 such that the cam distance 618 is substantially equal to a hypotenuse defined by the first distance 620 and the second distance 624. For example, if the first distance 622 is approximately 0.10 inches and the second distance is approximately 0.075 inches, then the cam distance 618 is approximately 0.125 inches.

In the closed position 602, the center of curvature 606 of the sealing surface 524 is substantially coincident with the central flow path axis 512. For example, the first axis 608 or the center of curvature 606 may be offset from the central flow path axis 512 by a relatively small or negligible distance. In this manner, the sealing surface 524 substantially aligns with, or is coincident with, a central axis of the seal 514 (e.g., the center of curvature 606 of the sealing surface 524 intersects a central flow path axis 512 of the seal 116). In this manner, a seal load is evenly or uniformly distributed about a circumference or perimeter of the seal 514.

In the closed position 602 shown in FIG. 6A, the double-offset pivot 616 has an initial angle 626 relative to the first axis 608 of FIG. 6A. The initial angle 626 may be greater than zero degrees and less than 90 degrees relative to either of the first axis 608 or the second axis 610 when the flow control member 502 is in the closed position 602. For example, the initial angle 626 of the double offset pivot 616 may be approximately negative 17 degrees relative to the first axis 608 when the flow control member 502 is at the closed position 602.

In operation, the sealing surface 524 rotates relative to the pivot 616 through a 90 degree rotation between the closed position 602 and the open position 604. In particular, the sealing surface 524 rotates between a fully closed position when the flow control member 502 (e.g., the second axis 610) is at a zero degree rotational position relative to the central flow path axis 512 and a fully open position when the flow control member 502 (e.g., the second axis 610) is at a ninety degree rotational position relative to the central flow path axis 512.

The sealing surface 524 sealingly engages the seal 514 with substantial interference to provide a relatively tight seal to prevent fluid flow along the fluid flow passageway 506 when the flow control member 502 is in the closed position 602. In the closed position 602, the center of curvature 606 of the sealing surface 524 is substantially aligned with the central flow path axis 512. An outer most tangent 630 of the sealing surface 524 that is substantially parallel to the face 526 of the seal 514 is spaced at an initial lateral distance from the face 526 of the seal 514 when the flow control member 502 is in the closed position.

As the sealing surface 524 rotates relative to the seal 514 between the closed position 602 and the open position 604, the notched portion 530 of the flow control member 502 provides fluid communication between the inlet 508 and the outlet 510 to provide gradual increase in the amount of fluid flow along the fluid flow passageway 506. During a first rotational position range of the flow control member 502 (e.g., a five degree rotation relative to the central flow path axis 512), the notched portion 530 provides a relatively small fluid flow rate along the fluid flow passageway 506, thereby providing an accurate or precise fluid flow control. The flow control member 502 provides a more precise fluid flow control than the flow control member 402 of FIGS. 4A and 4B because the sealing surface 524 pulls away from the seal 514 a smaller lateral distance than the sealing surface 420 pulls away from the seal 406 of FIG. 4A during the initial rotational position range.

Further, as the flow control member 502 rotates to the open position 604, the center of curvature 606 of the sealing surface 524 rotates or moves relative to the pivot 616. For example, the center of curvature 606 of the sealing surface 524 is at a first position relative to the seal 514 when the flow control member 502 is in the closed position 602, and a second position that is further away from the seal 514 than the first position when the flow control member 502 is in the open position 604. In the open position 604, an outer most tangent 632 of the sealing surface 524 that is parallel to the face 526 of the seal 514 is at a second position away from the initial tangent 630 such that a lateral distance 634 between the tangents 630 and 632 is greater than the lateral offset distance 620.

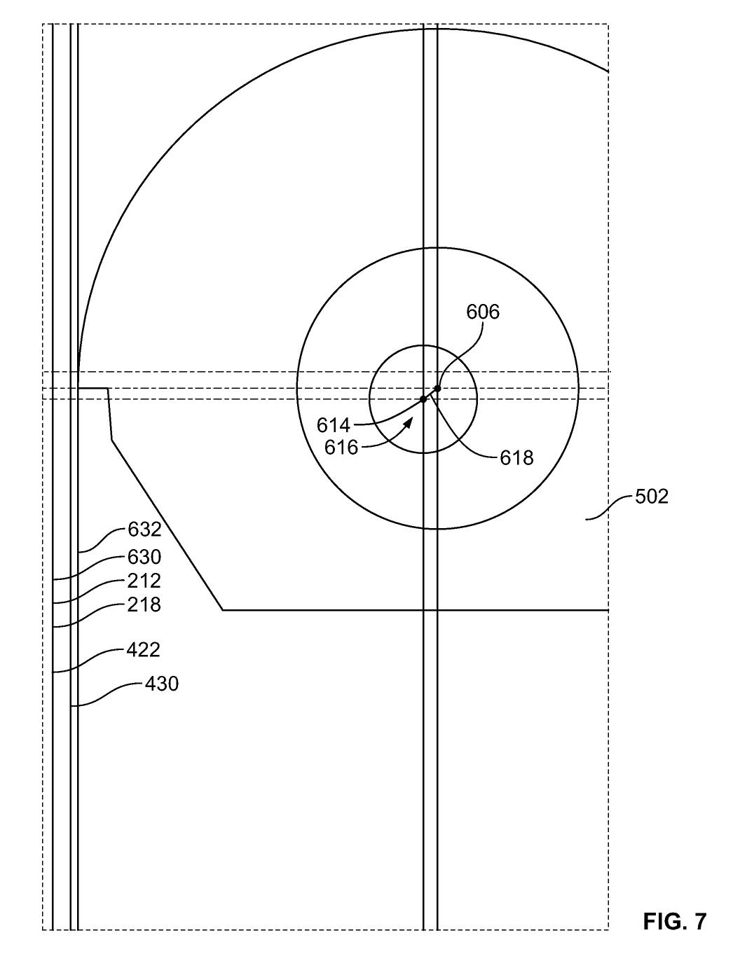

FIG. 7 is an enlarged portion of the flow control member 502 shown in the open position 604. Further, FIG. 7 illustrates the outer most tangents 218, 430, 632 or pull back of the respective flow control members or valve plugs 114, 402 and 502 in relation to their respective initial tangents 212, 422 and 630. As shown, the pull back or the tangent 632 of the flow control member 502 is offset relative to the initial or initial tangent 630 at a greater distance than the pull back of the outer most tangents 218 and 422 of the respective valve plugs 114 and 402. Thus, although the initial lateral offset 620 is less than the initial lateral offset 412 of the valve plug 402 of FIG. 4A, the offset or pull back 632 of the flow control member 502 is greater than the pull back or offset 430 of the valve plug 402 of FIG. 4B.

Unlike the valve plug 402 of FIGS. 4A and 4B, the double lateral offset connection enables the flow control member 502 to move away or pull back from the face 526 of the seal 514 a relatively smaller lateral distance during a first rotational range (e.g., between about a five degree rotation and a fifteen degree rotation) as the flow control member 502 moves from the closed position 602 to the open position 604 to provide a more precise or smaller fluid flow rate. Further, like the valve plug 402 of FIGS. 4A and 4B, the double offset lateral connection enables the flow control member 502 to move away from the face 526 of the seal 514 a relatively greater lateral distance during a second rotational range (e.g., between about a fifteen degree rotation and a ninety degree rotation) as the flow control member 502 moves from the closed position 602 to the open position 604.

In this manner, an interference between the sealing surface 524 and the seal 514 is substantially reduced or eliminated when the flow control member 502 moves to the open position 604 while providing precise or controlled fluid flow during an initial rotational position range. Thus, when the flow control member 502 is in the open position 604 for an extended period of time (e.g., during a failure condition, a normally open valve position, etc.), a portion of the seal 514 between the notched portion 530 will not become deformed or damaged because the sealing surface 524 pulls back away from the seal 514 provided by the double-offset connection to enable the sealing surface 524 to eliminate or significantly reduces interference with the seal 514. Further, the initial offset 620 is less than the pull back or offset 634. As a result, the pull back 634 of the sealing surface 524 relative to the seal 514 is smaller during a first rotational range of the sealing surface 524 so that a relatively small fluid flow can be achieved. Also, because the initial offset 620 is relatively less than, for example, the initial offset 412 of the valve plug 402 of FIGS. 4A and 4B, the flow control member 502 significantly reduces the likelihood of interference between the valve body 504 (e.g., between the shaft 518 and the bore 522 of the bonnet 520, a boundary of the fluid flow path) or other components of the valve body 504. As a result, the double-offset connection shown in FIGS. 5, 6A and 6B can be used with known rotary valve bodies without modification of the valve body.

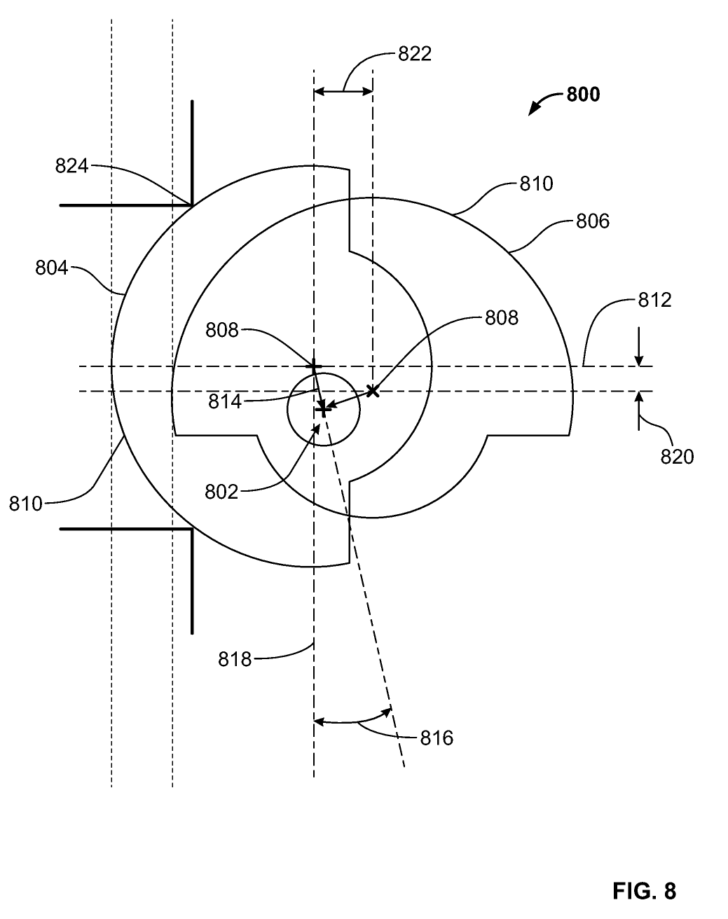

FIG. 8 illustrates a flow control member 800 having a double-offset pivot 802. FIG. 8 illustrates the flow control member 800 in a closed position 804 and in an open position 806. In the closed position 804, a center of curvature 808 of a sealing surface 810 is substantially coincident with a seal center line 812 and rotates about the double-offset pivot 802. In the closed position 804, the double-offset pivot 802 is at a cam distance 814 away from the center of curvature 808 and has a initial angle 816 relative to a first axis or axis of symmetry 818 of the flow control member 800 that intersects the center of curvature 808.

FIG. 8 illustrates an offset distance or position 820 of the center of curvature 808 relative to a seal center line 812 as the flow control member 800 rotates or moves from the closed position 804 to the open position 806. Also, FIG. 8 illustrates a move back distance or position 822 that the center of curvature 808 moves relative to a seal 824 along the seal center line 812 as the flow control member 800 rotates between the closed position 804 and the open position 806.

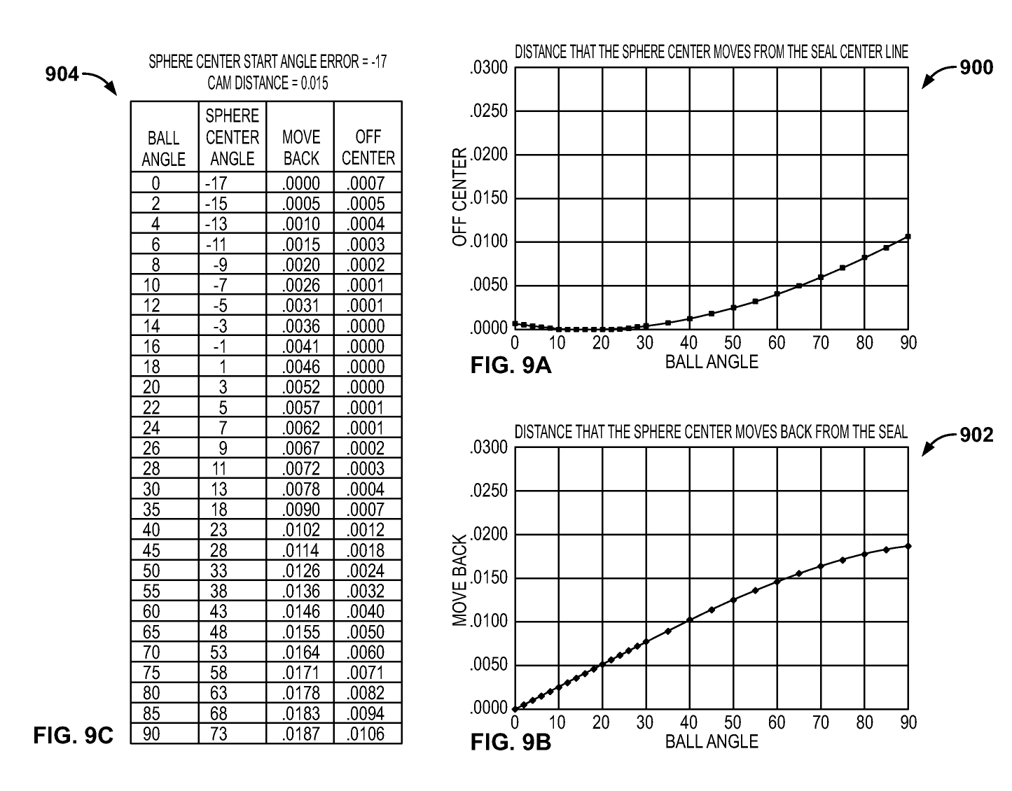

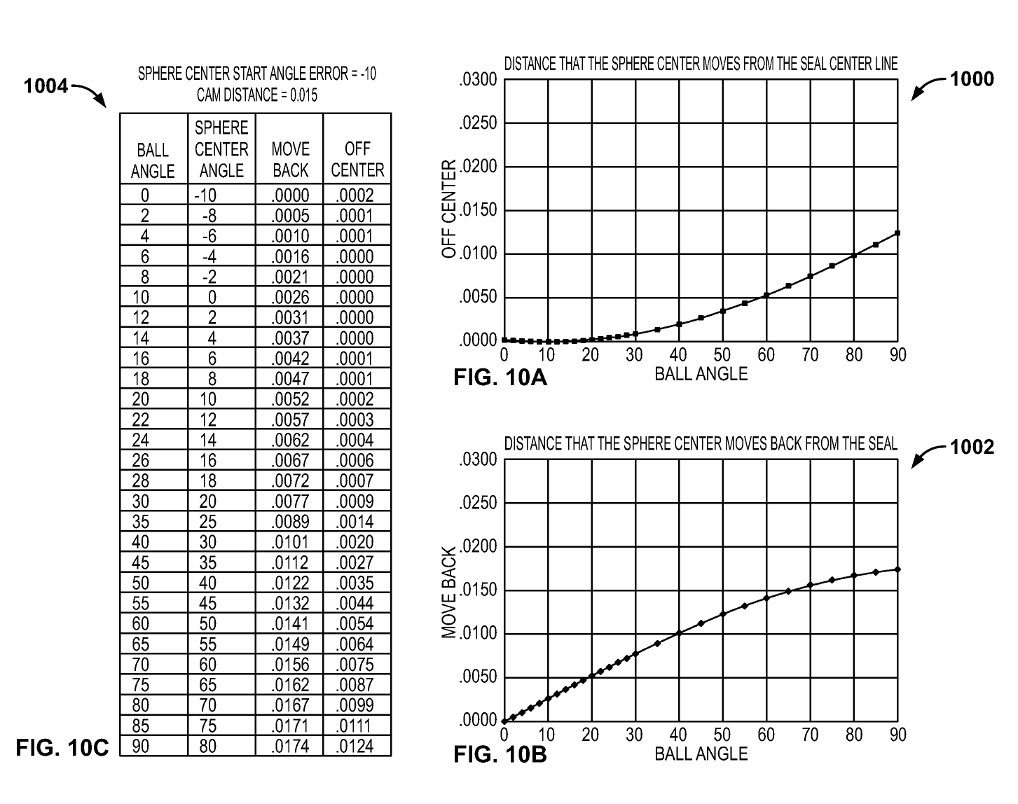

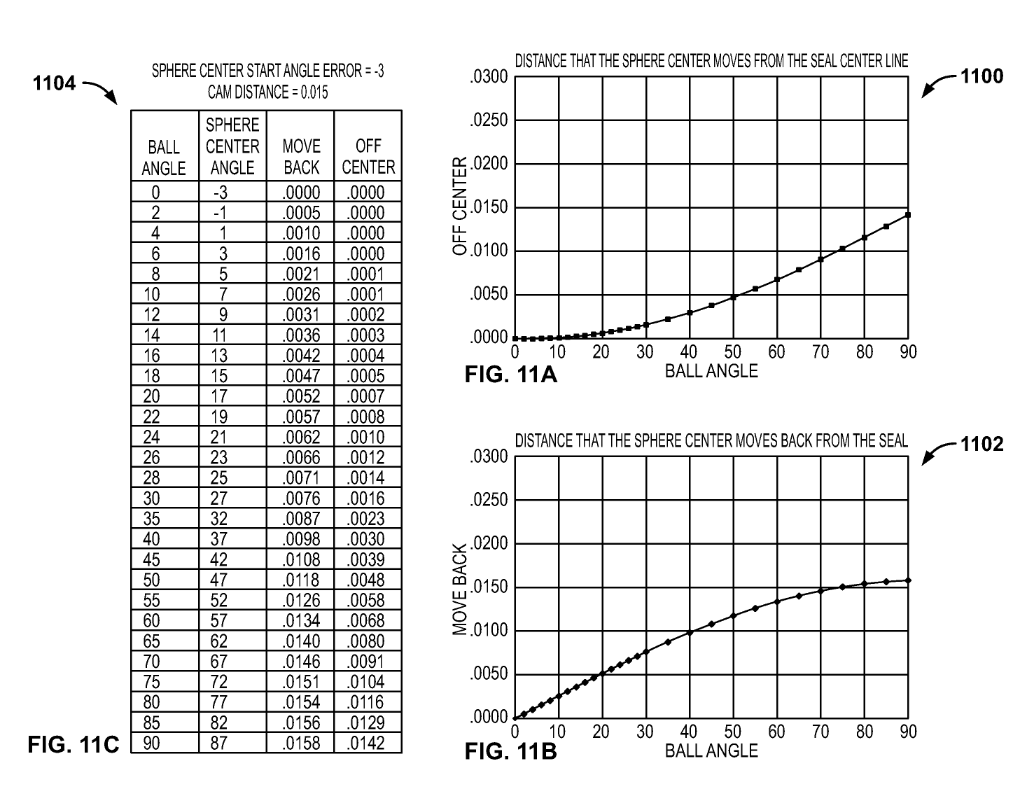

FIGS. 9A, 10A and 11A are respective graphical representations 900, 1000 and 1100 of example offset positions 820 achieved by different starting or initial angles 816. FIGS. 9B, 10B and 11B are respective graphical representations 902, 1002 and 1102 of example move back positions 822 achieved by different starting angles 816. For example, FIGS. 9A and 9B illustrate respective positions 820 and 822 when the starting angle 816 is negative 17 degrees and the cam distance is 0.015 inches. FIGS. 10A and 10B illustrate distances or positions 820 and 822 when the starting angle 816 is negative 10 degrees and the cam distance is 0.015 inches. FIGS. 11A and 11B illustrate distances 820 and 822 when the starting angle 816 is negative 3 degrees and the cam distance is 0.015 inches. FIGS. 9C, 10C and 11C show the graphical results of the respective graphs 900, 902, 1000, 1002, 1100 and 1102 in a table format 904, 1004 and 1104.

Although certain apparatus have been described herein, the scope of coverage of this patent is not limited thereto. To the contrary, this patent covers all apparatus fairly falling within the scope of the appended claims either literally or under the doctrine of equivalents.

What is claimed is:

1. A flow control member for use with a rotary valve comprising:
a sealing surface to move relative to a seal, the flow control member having a first axis and a second axis substantially perpendicular to the first axis, the first and second axes intersecting a center of curvature of the sealing surface; and
an opening to receive a shaft, the opening having a third axis passing through the opening to define a pivot about which the sealing surface rotates, wherein the third axis is perpendicular to and offset from the first and second axes.

2. A flow control member of claim 1, wherein the first axis is substantially parallel to a flow path axis of the rotary valve when the flow control member is coupled to the rotary valve and the flow control member is in a closed position.

3. A flow control member of claim 2, wherein the first axis is coaxially aligned with the flow path axis when the flow control member is in the closed position.

4. A flow control member of claim 2, wherein the first axis is offset relative to the flow path axis when the flow control member is in the closed position.

5. A flow control member of claim 1, wherein the second axis is substantially perpendicular to a flow path axis of the rotary valve when the flow control member is in a closed position and the second axis is substantially parallel to the flow path axis when the flow control member is in an open position.

6. A flow control member of claim 5, wherein the second axis is offset relative to the flow path axis when the flow control member is in the open position.

7. A flow control member of claim 1, wherein the pivot lies at an angle greater than 0 degrees and less than 90 degrees relative to the center of curvature of the sealing surface and one of the first axis or the second axis.

8. A flow control member of claim 7, wherein the angle is approximately between negative 1 and negative 45 degrees relative to the second axis when the flow control member is in a closed position.

9. A flow control member of claim 1, wherein the flow control member comprises a ball valve.

10. A flow control member of claim 9, wherein the ball valve comprises a segmented ball valve or a micro-V notch ball valve.

11. A flow control member of claim 1, wherein the sealing surface comprises a spherical sealing surface.

12. A valve plug comprising
a sealing surface to engage a seal of a fluid valve, the sealing surface having a center of curvature defined at least in part by a radius of curvature of the sealing surface; and
an opening to receive a shaft, the opening having a central axis that is offset by a cam distance relative to the center of curvature of the sealing surface such that the sealing surface moves in a cammed or eccentric manner about the central axis of the opening, wherein the cam distance is defined by a first distance relative to the center curvature and a second distance relative to the center of curvature.

13. A valve plug of claim 12, wherein the first distance is substantially perpendicular to the second distance.

14. A valve plug of claim 13, wherein the first distance is between approximately 0.05 and 0.25 inches and the second distance is between approximately 0.01 and 0.15 inches such that the cam distance is between approximately 0.051 and 0.3 inches.

15. A fluid valve, comprising:
a valve plug having a sealing surface that is to rotate relative to a seal of a valve body to control a fluid flow between an inlet and an outlet of the valve body; and
a shaft to operatively couple the valve plug to an actuator, the shaft being eccentrically coupled to the valve plug to define a double-offset pivot about which the sealing surface rotates between a fully open position and a fully closed position.

16. A fluid valve of claim 15, wherein the sealing surface has a center of curvature that is defined at least in part by a radius of curvature of at least a portion of the sealing surface, and wherein the valve plug has a first axis and a second axis intersecting the center of curvature of the sealing surface.

17. A fluid valve of claim 16, wherein a distance between the center of curvature of the sealing surface and the double-offset pivot is defined by a first distance in a first direction away from the center of curvature along the first axis and a second distance in a second direction away from the first axis, the first direction being perpendicular to the second direction.

18. A fluid valve of claim 15, wherein the sealing surface is movable through a 90 degree rotation relative to the seal when the valve plug moves between the fully closed position and the fully open position.

19. A valve plug and shaft connection comprising:
means for controlling fluid flow through a fluid flow passageway of a valve body; and
means for moving the means for controlling the fluid flow about a double-offset pivot.
